(19) United States
(12) Patent Application Publication
(10) Pub. No.: US 2025/0201889 A1
(43) Pub. Date: Jun. 19, 2025

(54) POWER STORAGE STACK

(71) Applicant: TOYOTA JIDOSHA KABUSHIKI KAISHA, Toyota-shi (JP)

(72) Inventor: Yoshiro KAMO, Kanagawa-ken (JP)

(73) Assignee: TOYOTA JIDOSHA KABUSHIKI KAISHA, Toyota-shi (JP)

(21) Appl. No.: 18/799,364

(22) Filed: Aug. 9, 2024

(30) Foreign Application Priority Data
Dec. 13, 2023 (JP) 2023-209868

(51) Int. Cl. H01M 10/04; H01M 10/613; H01M 10/653

(52) U.S. Cl. CPC H01M 10/04; H01M 10/613; H01M 10/653

(57) ABSTRACT

The power storage stack includes multiple power storage modules arranged in a first direction and a conductive member disposed between adjacent power storage modules, and the conductive member has a first face and a second face. The first face is fixed to the power storage module located on one side in the first direction by a first conductive adhesive, and the second face is fixed to the power storage module located on the other side in the first direction by a second conductive adhesive. The first conductive adhesive includes multiple first coating portions spaced side by side in a second direction, and the second conductive adhesive includes multiple second coating portions spaced side by side in a second direction. When viewed from the first direction, the multiple first coating portions and the multiple second coating portions are disposed so as not to overlap each other.

### CROSS-REFERENCE TO RELATED APPLICATION

This application claims priority to Japanese Patent Application No. 2023-209868 filed on Dec. 13, 2023, incorporated herein by reference in its entirety.

### BACKGROUND

### 1. Technical Field

The present disclosure relates to a power storage stack.

### 2. Description of Related Art

Japanese Unexamined Patent Application Publication No. 2021-86661 (JP 2021-86661 A) discloses, as a conventional power storage stack, a configuration in which a unit, in which a first current collector plate, a heat exchanger, and a second current collector plate are stacked in this order, is disposed between a first power storage module and a second power storage module. The first current collector plate is fixed to a principal face of the heat exchanger situated on one side in a stacking direction by a first adhesive, and the second current collector plate is fixed to a principal face of the heat exchanger situated on the other side in the stacking direction by a second adhesive. The heat exchanger exchanges heat with the first power storage module via the first current collector plate, and exchanges heat with the second power storage module via the second current collector plate. The heat exchanger, the first current collector plate, and the second current collector plate are positioned by the first adhesive and the second adhesive, and accordingly the positions of the heat exchanger, the first current collector plate, and the second current collector plate can be suppressed from being displaced from each other.

### SUMMARY

In the power storage stack, there are cases in which a conductive member is disposed between adjacent power storage modules, and the conductive member and the adjacent power storage modules are partially fixed by a conductive adhesive. In this case, depending on a position of applying the conductive adhesive, there is a concern that temperature variance will occur when the power storage module generates heat due to electricity being conducted or the like.

The present disclosure has been made in view of the above-described problem, and an object of the present disclosure is to provide a power storage stack capable of suppressing variance in temperature.

A power storage stack according to the present disclosure includes a plurality of power storage modules arrayed in a first direction, and a conductive member disposed between each of the power storage modules adjacent to each other in the first direction.

The conductive member includes a first face situated on one side in the first direction, and a second face situated on another side in the first direction.

The first face is fixed by a first conductive adhesive to the power storage module situated on one side in the first direction with respect to the conductive member.

The second face is fixed by a second conductive adhesive to the power storage module situated on the other side in the first direction with respect to the conductive member.

The first conductive adhesive includes, at least in part, a plurality of first coating portions laid out arrayed with intervals therebetween in a second direction orthogonal to the first direction.

The second conductive adhesive includes, at least in part, a plurality of second coating portions laid out arrayed with intervals therebetween in the second direction.

The first coating portions and the second coating portions are laid out so as not to overlap each other as viewed from the first direction.

In the power storage stack according to the present disclosure,
the first conductive adhesive may include a first connecting portion connecting to each other the first coating portions that are adjacent in the second direction.

The second conductive adhesive may include a second connecting portion connecting to each other the second coating portions that are adjacent in the second direction.

At least a portion of the first connecting portion and the second connecting portion may overlap as viewed from the first direction.

In the power storage stack according to the present disclosure, in at least one of the first coating portions and the second coating portions, electric conductivity of the coating portions disposed on both end sides in the second direction may be greater than electric conductivity of the coating portions disposed in a middle side in the second direction.

The power storage stack according to the present disclosure may further include
a first current collector plate and a second current collector plate disposed so as to sandwich, in the first direction, the power storage modules and the conductive member disposed between each of the power storage modules adjacent to each other in the first direction.

Each of the power storage modules includes a first principal face situated on the one side in the first direction and a second principal face situated on the other side in the first direction. In this case, the first principal face of the power storage module situated on the farthest one side in the first direction of the power storage modules may be fixed to the first current collector plate by a third conductive adhesive, and
the second principal face of the power storage module situated on the farthest other side in the first direction of the power storage modules may be fixed to the second current collector plate by a fourth conductive adhesive.

Further, the third conductive adhesive may include, at least in part, a plurality of third coating portions laid out arrayed with intervals therebetween in the second direction, and
the fourth conductive adhesive may include, at least in part, a plurality of fourth coating portions laid out arrayed with intervals therebetween in the second direction.

In at least one of the third coating portions and the fourth coating portions, electrical conductivity of the coating portions disposed on both end sides in the second direction may be greater than electrical conductivity of the coating portion disposed in the middle side in the second direction.

In the power storage stack according to the present disclosure, in at least one of the third coating portions and the fourth coating portions, an interval in the second direction of the coating portion disposed on both end sides in the second direction may be smaller than an interval in the second direction of the coating portion disposed in the middle portion in the second direction.

In the power storage stack according to the present disclosure, in at least one of the third coating portions and the fourth coating portions, a content of fine metal particles contained in the coating portion disposed on both end sides in the second direction may be greater than a content of fine metal particles contained in the coating portion disposed in the middle portion in the second direction.

According to the present disclosure, a power storage stack capable of suppressing temperature variance can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a power storage device according to a first embodiment;

FIG. 2 is a schematic cross-sectional view along II-II shown in FIG. 1;

FIG. 3 is a schematic plan view illustrating shapes and positional relationships of a first conductive adhesive and a second conductive adhesive in the power storage device according to Embodiment 1;

FIG. 4 is a schematic cross-sectional view of a power storage device according to Embodiment 2; and

FIG. 5 is a schematic plan view illustrating shapes and positional relationships of a first conductive adhesive and a second conductive adhesive in the power storage device according to Embodiment 3.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### Embodiment 1

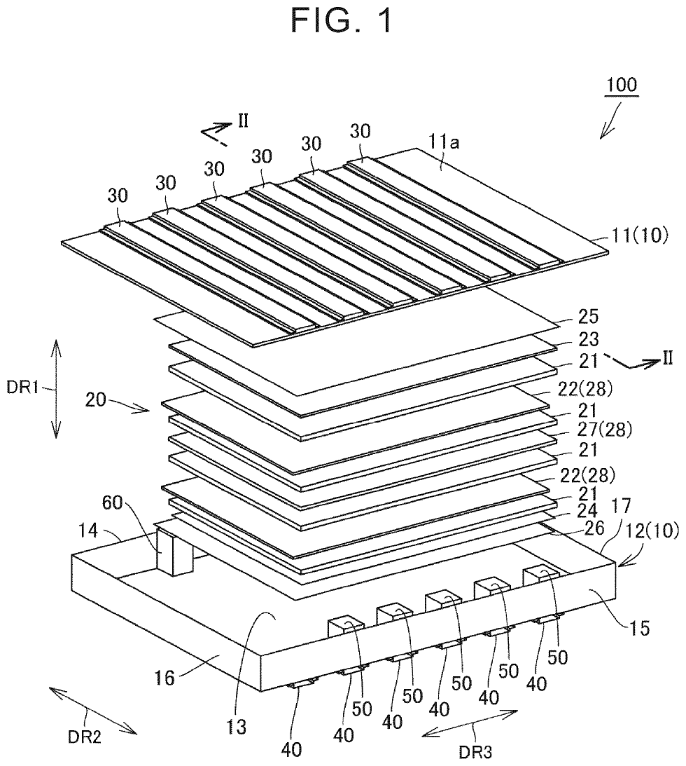

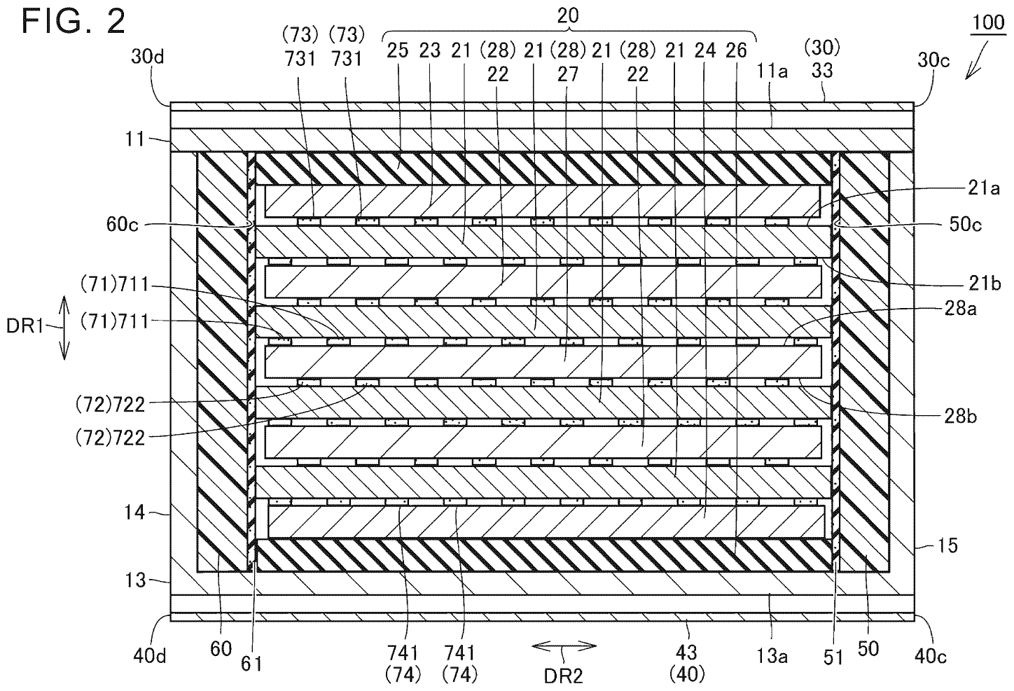

FIG. 1 is an exploded perspective view of a power storage device according to a first embodiment. FIG. 2 is a schematic cross-sectional view taken along II-II line shown in FIG. 1. The power storage device 100 according to the first embodiment will be described with reference to FIGS. 1 and 2.

The power storage device 100 is mounted in a vehicle such as a hybrid electric vehicle that can travel using at least one of motor and engine power, or an electrified vehicle that travels using a driving force obtained by electric energy.

The power storage device 100 includes a housing case 10, a power storage stack 20, and a plurality of stoppers 50 and 60.

The power storage stack 20 includes a plurality of power storage modules 21, a first current collector plate 23 and a second current collector plate 24, insulating sheets 25 and 26, a plurality of conductive members 28, a first conductive adhesive 71, a second conductive adhesive 72, a third conductive adhesive 73, and a fourth conductive adhesive 74.

The plurality of power storage modules 21 are arranged in the first direction (DR1 direction). The first direction is parallel to the vertical direction of the vehicle in the mounted state in which the power storage device 100 is mounted on the vehicle.

The plurality of power storage modules 21 are, for example, so-called bipolar batteries. More specifically, the power storage module 21 is a laminated water-based battery, and is a secondary battery such as a lithium-ion battery. Note that the power storage module 21 is not limited to the above, and may be constituted by an all-solid-state battery, a capacitor, or the like. Each of the plurality of power storage modules 21 has a first principal face 21a located on one side in the first direction and a second principal face 21b located on the other side in the first direction.

The plurality of conductive members 28 includes a plurality of coolers 22 and conductive plates 27. The plurality of coolers 22 are disposed between the power storage modules 21 adjacent to each other. The plurality of coolers 22 are provided with a refrigerant flow path through which the refrigerant can flow. The cooler 22 cools the power storage module 21.

The conductive plate 27 is disposed between the power storage modules 21 adjacent to each other. Specifically, the conductive plate 27 is disposed between the two coolers 22 facing each other in the first direction and between the power storage modules 21 adjacent to each other.

The conductive member 28 has a first face 28a located on one side in the first direction and a second face 28b located on the other side in the first direction.

The first face 28a is fixed to the power storage module 21 located on one side in the first direction with respect to the conductive member 28 by the first conductive adhesive 71. More specifically, the first face 28a is fixed to the second principal face 21b of the power storage module 21.

The second face 28b is fixed to the power storage module 21 located on the other side in the first direction with respect to the conductive member 28 by the second conductive adhesive 72. More specifically, the second face 28b is fixed to the first principal face 21a of the power storage module 21.

The first current collector plate 23 is stacked on one side in the first direction of the power storage module 21 located on the one-most side in the first direction. The first current collector plate 23 is fixed to the first principal face 21a of the power storage module 21 located on the one-most side in the first direction by the third conductive adhesive 73. The first current collector plate 23 is, for example, a current collector plate for a positive electrode. The first current collector plate 23 is connected to a positive electrode terminal (not shown).

The second current collector plate 24 is stacked on the other side in the first direction of the power storage module 21 located on the other side in the first direction. The second current collector plate 24 is fixed to the second principal face 21b of the power storage module 21 located on the other side in the first direction by the fourth conductive adhesive 74. The second current collector plate 24 is, for example, a current collector plate for a negative electrode. The second current collector plate 24 is connected to a negative electrode terminal (not shown). The negative electrode terminal and the positive electrode terminal described above are used to charge and discharge the power storage stack 20.

An insulating sheet 25 is disposed on one side of the first current collector plate 23 in the first direction. An insulating sheet 26 is disposed on the other side of the second current collector plate 24 in the first direction.

The housing case 10 accommodates the power storage stack 20 and the plurality of stoppers 50 and 60 therein. The housing case 10 includes a restraining plate 11 constituting a ceiling portion and a lower case 12.

The restraining plate 11 has a plate-like shape. The restraining plate 11 may be formed of, for example, a metallic member such as a SUS. The restraining plate 11 is fastened and fixed to the side wall portion of the lower case 12 using a fastening member such as a bolt.

The restraining plate 11 has an outer principal face 11a that is located on a side opposite to a side on which the power storage stack 20 is located. A plurality of reinforcing portions 30 are provided on the outer principal face 11a.

Each of the plurality of reinforcing portions 30 is provided so as to extend along a second direction (DR2 direction) perpendicular to the first direction. For example, the plurality of reinforcing portions 30 extend from one end of the restraining plate 11 in the second direction to the other end of the restraining plate 11 in the second direction.

The plurality of reinforcing portions 30 are arranged side by side in a third direction (DR3 direction) perpendicular to the first direction and the second direction. The plurality of reinforcing portions 30 may be welded to the restraining plate 11 by welding or the like, or may be fixed to the restraining plate 11 by a fastening member. The plurality of reinforcing portions 30 may be formed of a metallic member such as a SUS.

The lower case 12 has a substantially box-shaped shape that opens toward one side in the first direction. The lower case 12 may be formed of, for example, a metallic member such as a SUS. The lower case 12 includes a restraining plate 13 as a bottom portion and a plurality of side wall portions 14 to 17.

The restraining plate 13, like the restraining plate 11, has a plate-like shape. The restraining plate 13 faces the restraining plate 11 in the first direction. The power storage stack 20 is restrained by sandwiching the power storage stack 20 between the restraining plate 11 and the restraining plate 13.

The restraining plate 13 has an outer principal face 13a that is located on a side opposite to a side on which the power storage stack 20 is located. A plurality of reinforcing portions 40 are provided on the outer principal face 13a.

Each of the plurality of reinforcing portions 40 is provided so as to extend along the second direction. The plurality of reinforcing portions 40 may be welded to the restraining plate 13 by welding or the like, or may be fixed to the restraining plate 11 by a fastening member. The plurality of reinforcing portions 40 have substantially the same configuration as the plurality of reinforcing portions 30. The plurality of reinforcing portions 40 are provided at positions corresponding to the plurality of reinforcing portions 30. The plurality of reinforcing portions 40 are provided at positions opposed to the plurality of reinforcing portions 30 in the first direction.

The plurality of stoppers 50 and 60 are disposed on both outer sides of the power storage stack 20 in the second direction.

Specifically, the plurality of stoppers 60 are disposed between the power storage stack 20 and the side wall portion 14 on one side in the second direction. The plurality of stoppers 60 are arranged side by side at intervals in the third direction.

The plurality of stoppers 60 are disposed at positions overlapping the corresponding reinforcing portions 30 and 40 in the first direction on the first end portion 30c, 40c side in the second direction of the corresponding reinforcing portion among the plurality of reinforcing portions 30 and 40. Each of the plurality of stoppers 60 is fixed to the corresponding reinforcing portions 30 and 40 by, for example, a fastening member 70.

The plurality of stoppers 50 are disposed between the power storage stack 20 and the side wall portion 15 on the other side in the second direction. The plurality of stoppers 50 are arranged side by side at intervals in the third direction.

The plurality of stoppers 50 are disposed at positions overlapping the corresponding reinforcing portions 30 and 40 in the first direction on the second end portion 30d, 40d side in the second direction of the corresponding reinforcing portion among the plurality of reinforcing portions 30 and 40. Each of the plurality of stoppers 50 is fixed to the corresponding reinforcing portions 30 and 40 by, for example, a fastening member 70.

Each of the plurality of stoppers 50 and 60 has inner surfaces 50c, 60c facing toward the power storage stack 20. Insulating members 51 and 61 may be provided on the inner surfaces 50c, 60c. Thus, even when the stoppers 50 and 60 are cooled, it is possible to suppress the occurrence of dew condensation on the side of the power storage stack 20.

Note that the fixing mode of the plurality of stoppers 50 and 60 is not limited to the fastening and fixing, and can be appropriately selected such as the adhesive fixing, the welding fixing, and the like.

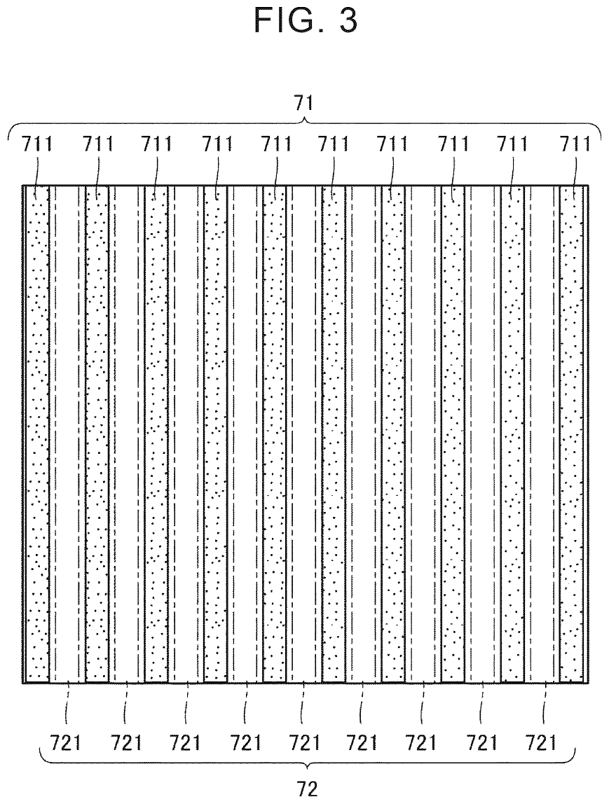

FIG. 3 is a schematic plan view illustrating shapes and positional relationships of a first conductive adhesive and a second conductive adhesive in the power storage device according to Embodiment 1. The first conductive adhesive 71 and the second conductive adhesive 72 will be described in detail with reference to FIG. 3.

The first conductive adhesive 71 and the second conductive adhesive 72 are formed by mixing metal particles into a resin adhesive. For example, the first conductive adhesive 71 and the second conductive adhesive 72 are made of epoxy resin mixed with a metal filler such as nickel. The third conductive adhesive 73 and the fourth conductive adhesive 74 described above are also the same as the first conductive adhesive 71 and the second conductive adhesive 72.

The first conductive adhesive 71 includes a plurality of first coating portions 711 arranged side by side at intervals in the second direction. Similarly, the second conductive adhesive 72 includes a plurality of second coating portions 721 spaced side by side in a second direction.

By providing the first conductive adhesive 71 and the second conductive adhesive 72 in this manner, the area of the adhesive can be reduced as compared to when the adhesive is applied to the entire surface of the first face 28a and the second face 28b of the conductive member 28. As a result, the manufacturing cost can be reduced.

The ratio of the coating area of the first conductive adhesive 71 to the area of the first face 28a is, for example, 5% or more and 20%, and more specifically, 7% or more and 12% or less. The ratio of the coating area of the first conductive adhesive 71 to the area of the first face 28a may be, for example, about 10%.

Similarly, the ratio of the coating area of the second conductive adhesive 72 to the area of the second face 28b is, for example, 5% or more and 20%, and more specifically, 7% or more and 12% or less. The ratio of the coating area of the second conductive adhesive 72 to the area of the second face 28b may be, for example, about 10%.

In the present embodiment, the electrical conductivity of the plurality of first coating portions 711 is substantially the same, and the electrical conductivity of the plurality of second coating portions 721 is substantially the same. In addition, the first coating portion 711 and the second coating portion 721 have substantially the same electrical conductivity.

In general, since the conductive adhesive has electrical resistance, the temperature rises due to Joule heat generation during energization. When the plurality of first coating portions 711 and the plurality of second coating portions 721 are disposed to face each other on the first face 28a side and the second face 28b side of the conductive member 28, the first coating portion 711 and the second coating portion 721 face each other. For this reason, there is a concern that temperature variation occurs in the conductive member between a region where the first coating portion 711 and the second coating portion 721 are applied so as to face each other and a region where the first coating portion 711 and the second coating portion 721 are not applied. As a result, temperature variations may occur in the power storage module.

Here, in the present embodiment, the plurality of first coating portions 711 and the plurality of second coating portions 721 are arranged so as not to overlap each other when viewed from the first direction. More specifically, when viewed from the first direction, the first coating portion 711 and the second coating portion 721 are arranged alternately in the second direction. As described above, by arranging the plurality of first coating portions 711 and the plurality of second coating portions 721, it is possible to suppress the occurrence of temperature variation in the conductive member 28. As a result, it is possible to suppress the temperature variation of the power storage module 21 and consequently to suppress the temperature variation of the power storage stack 20. In particular, it is possible to effectively suppress the temperature variation of the power storage stack 20 during the high-load running or the rapid charging.

Referring again to FIG. 2, the third conductive adhesive 73 includes a plurality of third coating portions 731 arranged side by side at intervals in the second direction. Similarly, the fourth conductive adhesive 74 includes a plurality of fourth coating portions 741 spaced side by side in the second direction.

The plurality of third coating portions 731 located on the first principal face 21a of the power storage module 21 located on one side in the first direction and the plurality of first coating portions 711 located on the second principal face 21b of the power storage module 21 are arranged so as not to overlap each other when viewed from the first direction. Also in this case, when viewed from the first direction, the plurality of third coating portions 731 and the plurality of first coating portions 711 are arranged alternately in the second direction.

The plurality of second coating portions 721 located on the first principal face 21a of the power storage module 21 located on the other side in the first direction and the plurality of fourth coating portions 741 located on the second principal face 21b of the power storage module 21 are arranged so as not to overlap each other when viewed from the first direction. Also in this case, when viewed from the first direction, the plurality of second coating portions 721 and the plurality of fourth coating portions 741 are arranged alternately in the second direction.

With this configuration as well, it is possible to reduce the temperature variation of the power storage stack 20.

### Embodiment 2

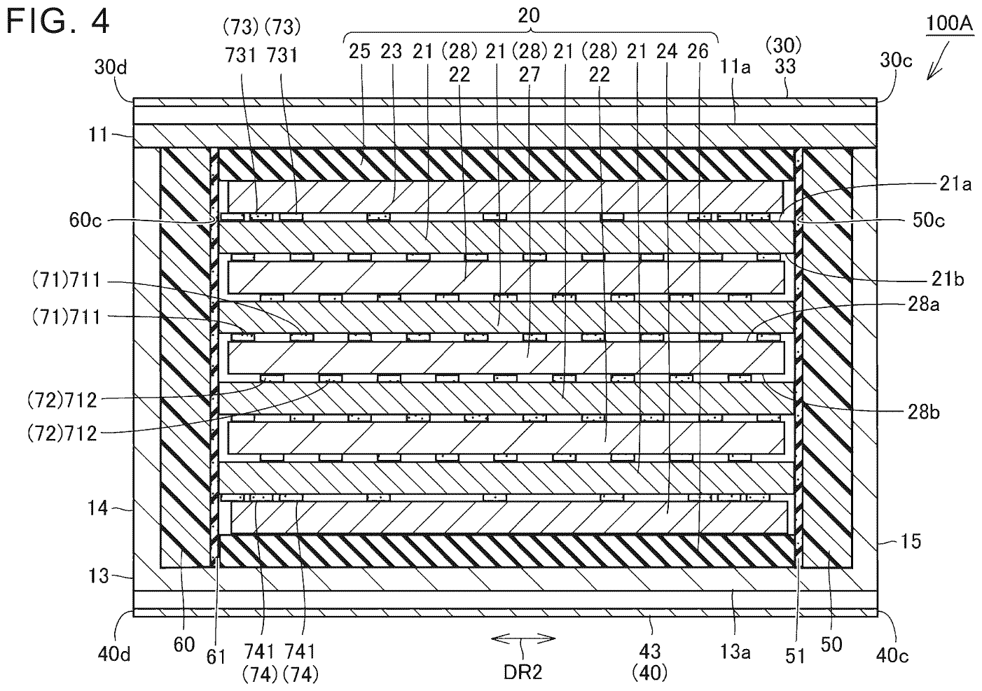

FIG. 4 is a schematic cross-sectional view of a power storage device according to Embodiment 2. Referring to FIG. 4, a power storage device 100A according to a second embodiment will be described. Incidentally, FIG. 4 is a cross-sectional view opposed to a schematic cross-sectional view taken along II-II line shown in FIG. 1.

As shown in FIG. 4, the power storage device 100A according to the second embodiment differs in the arrangement of the third conductive adhesive 73 and the fourth conductive adhesive 74 when compared with the power storage device 100 according to the first embodiment. Other configurations are substantially the same.

In the third conductive adhesive 73, the electrical conductivity of the third coating portion 731 disposed on both end sides in the second direction is larger than the electrical conductivity of the third coating portion 731 disposed on the center side in the second direction.

Specifically, for example, the interval in the second direction of the third coating portion 731 disposed at both end sides in the second direction is smaller than the interval in the second direction of the third coating portion 731 disposed at the center portion in the second direction.

Similarly, in the fourth conductive adhesive 74, the electric conductivity of the fourth coating portion 741 disposed on both end sides in the second direction is larger than the electric conductivity of the fourth coating portion 741 disposed on the center side in the second direction.

Specifically, for example, the interval in the second direction of the fourth coating portion 741 disposed at both end sides in the second direction is smaller than the interval in the second direction of the fourth coating portion 741 disposed at the center portion in the second direction.

In general, in the power storage stack 20, heat dissipation to the accommodation space tends to increase on the peripheral edge side of the current collector plate disposed on both end portions side in the stacking direction (first direction). Therefore, by increasing the electrical conductivity of the third coating portion 731 and the fourth coating portion 741 disposed in the region where the heat dissipation increases, it is possible to reduce the temperature variation caused by the heat dissipation.

In both of the third conductive adhesive 73 and the fourth conductive adhesive 74, the electric conductivity of the coating portion disposed on both end sides in the second direction is larger than the electric conductivity of the coating portion disposed in the central portion in the second direction, but the present disclosure is not limited thereto. In at least one of the third conductive adhesive 73 and the fourth conductive adhesive 74, it is sufficient that the relationship of the electrical conductivity is established.

Further, in the above description, as an example of adjusting the electrical conductivity, a case in which the distance between the coating portions is adjusted has been exemplified, but the present disclosure is not limited thereto. The content of the fine metal particles included in the coating portion disposed on both end sides in the second direction may be larger than the content of the fine metal particles included in the coating portion disposed in the central portion in the second direction. In this case, the distance between the plurality of coating portions may be constant.

### Embodiment 3

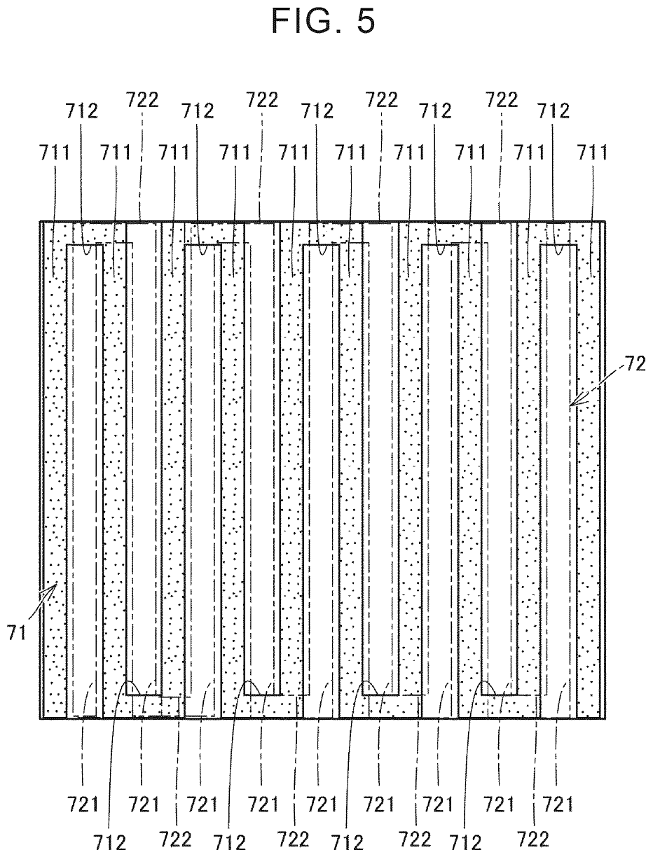

FIG. 5 is a schematic plan view illustrating shapes and positional relationships of a first conductive adhesive and a second conductive adhesive in the power storage device according to Embodiment 3. A power storage device according to a third embodiment will be described with reference to FIG. 5.

As shown in FIG. 5, in the power storage device according to Embodiment 3, the shapes of the first conductive adhesive 71 and the second conductive adhesive 72 are different from those of the power storage device 100 according to Embodiment 1. Other configurations are substantially the same.

The first conductive adhesive 71 includes a plurality of first coating portions 711 and a plurality of first connection portions 712. The plurality of first connecting portions 712 alternately connect the first coating portions 711 adjacent to each other on one side and the other side in the third direction.

The second conductive adhesive 72 includes a plurality of second coating portions 721 and a plurality of second connecting portions 722. The plurality of second connecting portions 722 alternately connect the second coating portions 721 adjacent to each other on one side and the other side in the third direction.

Even in the case of such a configuration, the power storage device according to the third embodiment has substantially the same effect as the power storage device 100 according to the first embodiment.

### Other Variations

In the first embodiment described above, the case where each of the plurality of first coating portions 711 and the plurality of second coating portions 721 has substantially the same electrical conductivity is exemplified, but the present disclosure is not limited thereto. In at least one of the plurality of first coating portions 711 and the plurality of second coating portions 721, the electrical conductivity of the coating portions disposed on both end sides in the second direction may be larger than the electrical conductivity of the coating portions disposed on the center side in the second direction.

In general, in the power storage module 21, the current density tends to be smaller in the direction of the end portion than in the central portion. By adjusting the electrical conductivity of the coating portion as described above, it is possible to reduce the temperature variation caused by the current density distribution.

As the adjustment of the electrical conductivity, specifically, for example, the distance in the second direction of the coating portion disposed on both end sides in the second direction may be smaller than the distance in the second direction of the coating portion disposed in the central portion in the second direction. Alternatively, the content ratio of the fine metal particles included in the coating portion disposed on both end sides in the second direction may be larger than the content ratio of the fine metal particles included in the coating portion disposed in the central portion in the second direction.

The embodiments disclosed herein are illustrative and not restrictive in all respects. The scope of the present disclosure is defined by the claims, and includes all modifications within the meaning and range equivalent to the claims.

What is claimed is:

1. A power storage stack, comprising:
a plurality of power storage modules arrayed in a first direction; and
a conductive member disposed between each of the power storage modules adjacent to each other in the first direction, wherein
the conductive member includes a first face situated on one side in the first direction, and a second face situated on another side in the first direction,
the first face is fixed by a first conductive adhesive to the power storage module situated on one side in the first direction with respect to the conductive member,
the second face is fixed by a second conductive adhesive to the power storage module situated on the other side in the first direction with respect to the conductive member,
the first conductive adhesive includes, at least in part, a plurality of first coating portions laid out arrayed with intervals therebetween in a second direction orthogonal to the first direction,
the second conductive adhesive includes, at least in part, a plurality of second coating portions laid out arrayed with intervals therebetween in the second direction, and
the first coating portions and the second coating portions are laid out so as not to overlap each other as viewed from the first direction.

2. The power storage stack according to claim 1, wherein
the first conductive adhesive includes a first connecting portion connecting to each other the first coating portions that are adjacent in the second direction,
the second conductive adhesive includes a second connecting portion connecting to each other the second coating portions that are adjacent in the second direction, and
at least a portion of the first connecting portion and the second connecting portion overlap as viewed from the first direction.

3. The power storage stack according to claim 1, wherein, in at least one of the first coating portions and the second coating portions, electric conductivity of the coating portions disposed on both end sides in the second direction is greater than electric conductivity of the coating portions disposed in a middle side in the second direction.

4. The power storage stack according to claim 1, further comprising a first current collector plate and a second current collector plate disposed so as to sandwich, in the first direction, the power storage modules and the conductive member disposed between each of the power storage modules adjacent to each other in the first direction, wherein
each of the power storage modules includes a first principal face situated on the one side in the first direction and a second principal face situated on the other side in the first direction,
the first principal face of the power storage module situated on the farthest one side in the first direction of the power storage modules is fixed to the first current collector plate by a third conductive adhesive,
the second principal face of the power storage module situated on the farthest other side in the first direction of the power storage modules is fixed to the second current collector plate by a fourth conductive adhesive,
the third conductive adhesive includes, at least in part, a plurality of third coating portions laid out arrayed with intervals therebetween in the second direction,
the fourth conductive adhesive includes, at least in part, a plurality of fourth coating portions laid out arrayed with intervals therebetween in the second direction, and
in at least one of the third coating portions and the fourth coating portions, electrical conductivity of the coating portions disposed on both end sides in the second direction is greater than electrical conductivity of the coating portion disposed in the middle side in the second direction.

5. The power storage stack according to claim 4, wherein, in at least one of the third coating portions and the fourth coating portions, an interval in the second direction of the coating portion disposed on both end sides in the second direction is smaller than an interval in the second direction of the coating portion disposed in the middle portion in the second direction.

6. The power storage stack according to claim 4, wherein, in at least one of the third coating portions and the fourth coating portions, a content of fine metal particles contained in the coating portion disposed on both end sides in the second direction is greater than a content of fine metal particles contained in the coating portion disposed in the middle portion in the second direction.
